(19) United States
(12) Patent Application Publication
(10) Pub. No.: US 2009/0068970 A1
(43) Pub. Date: Mar. 12, 2009

(54) SCANNING FREQUENCY OPTIMIZATION FOR ALTERNATE NETWORK ACCESS IN DUAL MODE WIRELESS DEVICES

(75) Inventors: Mohammed M. Ahmed, Schaumburg, IL (US); Kashyap Kamdar, Palatine, IL (US); Amol Tuli, Elgin, IL (US); Edgardo L. Promenzio, Round Lake, IL (US); Patrick A. Baumann, Phoenix, AZ (US); Ajaykumar R. Idnani, Schaumburg, IL (US); Edward J. Keating, Deer Park, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/853,279

(22) Filed: Sep. 11, 2007

(51) Int. Cl. H04B 1/18

(52) U.S. Cl. 455/161.1

(57) ABSTRACT

A method, information processing system, and wireless device are disclosed for managing network scanning intervals. The method includes detecting a new wireless network coverage area (130). At least one local dynamic scanning profile (110) is analyzed in response to the determining. The at least one local dynamic scanning profile (110) is determined to include identification information (306) associated with the new wireless network coverage area (130). A network scanning interval for identifying wireless sub-networks (112) within the new wireless network coverage area is dynamically adjusted in response to the determining that the at least one local dynamic scanning profile 110 includes the identification information (306). The adjustment is based on a scanning interval (312) indicated by the at least one local dynamic scanning profile 110 for the new wireless network coverage area (130).

### FIELD OF THE INVENTION

The present invention generally relates to the field of wireless communication systems, and more particularly relates to dynamically updating scanning intervals of a wireless device for identifying alternate networks.

### BACKGROUND OF THE INVENTION

Current wireless technology has spawned a new breed of wireless device, a dual-mode wireless device. Multi-mode wireless devices are capable of communicating over multiple separate network technologies such as a Global System for Mobile Communications (“GSM”) network and an Unlicensed Mobile Access (“UMA”), which generally comprises a Wireless Local Area Network (“WLAN”). A multi-mode wireless device in a UMA network generally has two types of profiles, manual and automatic, for associating with Wireless Fidelity (“WiFi”) Access Points.

In the manual mode the user explicitly instructs the handset to use/scan for WiFi networks. In the automatic mode, the WLAN radio on the handset periodically scans for WiFi signals, typically at a pre-configured interval such as 10 seconds. Having the handset operate in automatic mode is a more convenient and preferred way of operating. However, the automatic mode is a large drain on the battery of the wireless device because of the periodic waking up of the WLAN Radio and scanning for WiFi signals.

A wireless device may not be in an area providing WLAN coverage. Also, if the wireless device is in an area providing WLAN coverage, the wireless device may not be able to register on the network. Therefore, frequency scans for WLAN coverage in these areas unnecessarily drain the wireless device's battery. Additionally, the need for frequent recharging of the battery for UMA dual-mode wireless devices is a major drawback as it does not meet user expectations.

Therefore a need exists to overcome the problems with the prior art as discussed above.

### SUMMARY OF THE INVENTION

Briefly, in accordance with the present invention, disclosed are a method, information processing system, and wireless device for managing network scanning intervals. The method includes detecting a new wireless network coverage area. At least one local dynamic scanning profile is analyzed in response to the determining. The at least one local dynamic scanning profile is determined to include identification information associated with the new wireless network coverage area. A network scanning interval for identifying wireless sub-networks within the new wireless network coverage area is dynamically adjusted based on a scanning interval indicated by the at least one local dynamic scanning profile for the new wireless network coverage area in response to determining that the at least one local dynamic scanning profile includes the identification information.

In another embodiment, an information processing system for managing network scanning intervals is disclosed. The information processing system includes a memory and a processor that is communicatively coupled to the memory. A network scanning interval manager is communicatively coupled to the memory and the processor. The network scanning interval manager is adapted to receiving identifying information associated with a wireless network coverage area from a wireless device, when the wireless device registers with a WLAN network while being registered with the wireless network coverage area network. A master dynamic scanning profile that is associated with the wireless device is generated in response to receiving the identifying information associated wireless network coverage area. The master dynamic scanning profile includes at least identifying information associated with each wireless network coverage area network that overlaps with a WLAN network registered on by the wireless device and a scanning interval associated with each wireless network coverage area network. An optimized dynamic scanning profile is transmitted to the wireless device including at least a subset of the identifying information associated with each wireless network coverage area network and the scanning interval associated with each wireless network coverage area network corresponding to the subset of the identifying information.

In yet another embodiment, a wireless device is disclosed. The wireless device includes a memory and a processor that is communicatively coupled to the memory. A network scanning manager is communicatively coupled to the memory and the processor. The network scanning interval manager is adapted to detecting a new wireless network coverage area. At least one local dynamic scanning profile is analyzed in response to the determining. The at least one local dynamic scanning profile is determined to include identification information associated with the new wireless network coverage area coverage area. A network scanning interval for identifying wireless sub-networks within the new wireless network coverage area is dynamically adjusted based on a scanning interval indicated by the at least one local dynamic scanning profile for the new wireless network coverage area coverage area in response to determining that the at least one local dynamic scanning profile includes the identification information.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a wireless communication system according to an embodiment of the present invention;

FIG. 2 is a graphical diagram illustrating wireless coverage areas providing various levels of alternate network coverage according to an embodiment of the present invention;

FIG. 3 is a table illustrating a dynamic scanning profile according to an embodiment of the present invention;

FIG. 4 is a table illustrating another dynamic scanning profile according to an embodiment of the present invention;

FIG. 5 is a table illustrating yet another dynamic scanning profile according to an embodiment of the present invention;

FIG. 6 is a block diagram illustrating a wireless device according to an embodiment of the present invention;

FIG. 7 is a block diagram illustrating a information processing system according to an embodiment of the present invention;

FIG. 8 is an operational flow diagram illustrating a process of an network component generating a dynamic scanning profile for a wireless device according to an embodiment of the present invention;

FIG. 9 is an operational flow diagram illustrating a process of a wireless device dynamically adjusting its network scanning intervals in response to a dynamic scanning profile according to an embodiment of the present invention;

FIG. 10 is an operational flow diagram illustrating a process of a wireless device generating a dynamic scanning profile according to an embodiment of the present invention; and

FIG. 11 is an operational flow diagram illustrating another process of a wireless device generating a dynamic scanning profile according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and other devices.

One of the advantages of the present invention is that it allows a wireless device to dynamically adjust its network scanning intervals based on a dynamic scanning profile, which can be created by the wireless device or provided by a network component such as an application server. Based on the dynamic scanning profile, the wireless device can determine if it is near/far from a WLAN network. If the wireless device determines that it is far away from a WLAN network or at a distance greater than a given threshold, the wireless device can dynamically adjust its network scanning interval to a longer interval (i.e., do not scan as frequently or at all). This prevents the battery of the device from unnecessarily being drained. If the wireless device determines that near a WLAN network or at a distance within or equal to a given threshold, the wireless device can dynamically adjust its network scanning interval to a shorter interval (i.e., scan more frequently).

Wireless Communication System

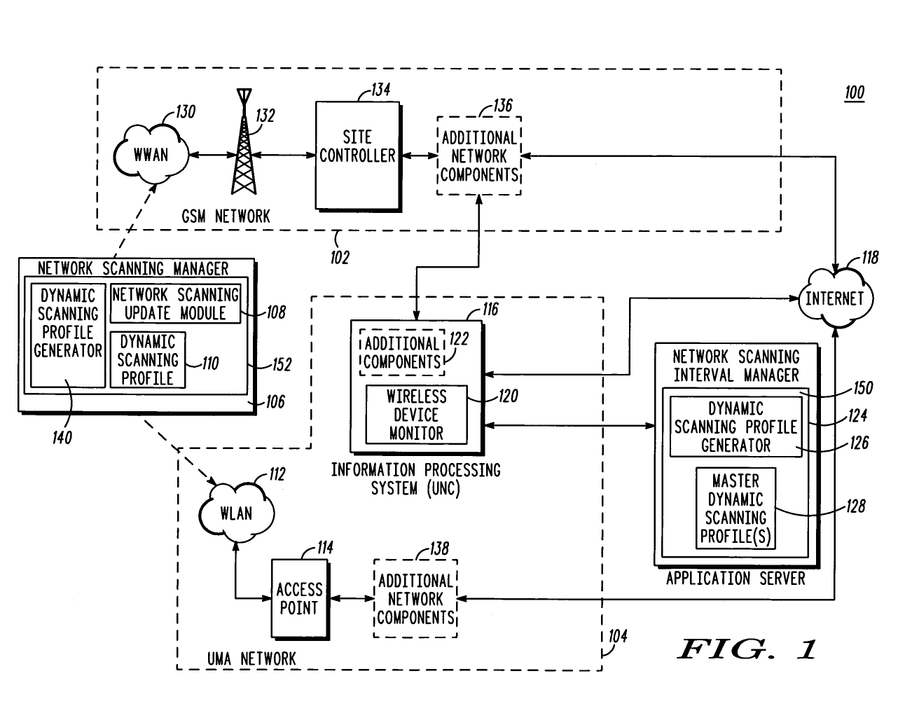

According to an embodiment of the present invention, as shown in FIG. 1, a wireless communication system 100 is illustrated. FIG. 1 shows the wireless communication system 100 comprising a circuit services network 102 such as a GSM network and a private network 104 such as an Unlicensed Mobile Access (“UMA”) network. It should be noted that the present invention is not limited to a GSM network or a UMA network, which have been used only as an example. Other wireless communication standards such as Code Division Multiple Access (“CDMA”), Time Division Multiple Access (“TDMA”), General Packet Radio Service (“GPRS”), Frequency Division Multiple Access (“FDMA”), Orthogonal Frequency Division Multiplexing (“OFDM”), or other technologies are also applicable to the present invention. Furthermore, the present invention is also not limited to a UMA network, any network providing WLAN connectivity is also applicable.

UMA or Generic Access Network (“GAN”) enables access to mobile voice, data, and IP Multimedia Subsystem (“IMS”) services over IP broadband access and unlicensed spectrum technologies such as Wireless Fidelity (“Wi-Fi”). Consequently, UMA describes a telecommunication network that allows seamless roaming and handover between Wireless Local Area Networks (“WLAN”) and Wide Area Networks (“WAN”) using dual mode communication devices. The WLAN, for instance, can be based on private unlicensed spectrum technologies, for example, Bluetooth, Wi-Fi, 802.11, infrared, or other technologies. The WAN on the other hand can be based on, for example, GSM, CDMA, GPRS, TDMA, FDMA, OFDM. UMA is therefore, an attempt towards convergence of mobile, fixed and Internet telephony.

The wireless communication system 100 includes one or more wireless devices 106 communicatively coupled to the circuit services network 102 and the private network 104. In one embodiment, the wireless device 106 is a multi-mode device capable of communicating on a wide area network such as the GSM network 102 and a local area network such as the private network 104. The multi-mode capabilities of the wireless device 106 allow it to selectively switch between networks such as WLANs and WANs to communicate with other users and access other services. The wireless device 106, in one embodiment, includes a network scanning manager 152 that includes a network scanning update module 108 and a dynamic scanning profile 110, which are discussed in greater detail below.

The private network 104 comprises one or more IP networks 112, e.g., WLANs, for providing IP based services to the wireless device 106. An IP network 112 can be a WLAN at a user's home, coffee shop, airport, hotel, and other technologies. The IP network 112, in one embodiment, provides data connections at much higher transfer rates than a traditional circuit services network. The IP network 112, in one embodiment, comprises an Evolution Data Only (“EV-DO”) network, a General Packet Radio Service (“GPRS”) network, a Universal Mobile Telecommunications System (“UMTS”) network, an 802.11 network, an 802.16 (WiMax) network, or the like. It should be noted that only one IP network 112 has been shown for simplicity. The private network also includes one or more access point(s) 114 that provides the wireless device 106 with wireless connectivity to each of the IP networks 112.

The private network 104 also includes an information processing system 116 such as an unlicensed network controller (“UNC”) 116. The UNC 116 couples an existing wide area network such as the GSM network 102 and an existing packet data network such as the IP network 112 to the access point 114. The UNC 116 can also connect to a public IP network such as the Internet 118 and the core mobile network using industry standard interfaces. The UNC 116 manages subscriber access to mobile voice and data services from the various WLAN locations. Generally, the private network 104 is within a residential network or an enterprise network within a user's home or situated in the customer site. As discussed above, the wireless device 106 is a multi-mode device and upon entering the private network 104, the wireless device establishes an IPsec tunnel through the IP network 104 to the UNC 116.

The UNC 116, in one embodiment, includes a wireless device monitor 120, which is discussed in greater detail below, and additional components 122. For example, a private security gateway or Packet Data Gateway (“PDG”) resides within the UNC 116. A PDG terminates the IP network connection and decrypts incoming traffic received at the UNC 116. A PDG also authenticates the wireless device 106 based on various information such as location, subscriber profile information, activity status information, and the like. An Authentication, Authorization, Accounting server (“AAA”) can also reside at the UNC 116. The UNC 116 can also include a Media Gateway (“MGW”) and Signalling Gateway (“SGW”), which provide translation between IP and circuit switched networks.

An IP Network Controller (“INC”) can also be included for providing management of security over the IP access network 112; control of packet mode and circuit-mode services; signaling interface processing; control of a MGW. These components and other components known to those of ordinary skill in the art can be communicatively coupled together by a router. It should be noted that the present invention is not limited to any of these additional components 122. One or more logical entities 124 such as application servers can be communicatively coupled to the UNC 116. Logical entities 124 host and execute various services associated with a wireless device 106. In one embodiment, the logical entity 124 includes a dynamic network scanning interval manager 150. The dynamic network scanning interval manager 150 includes a dynamic scanning profile generator 126 that creates one or more dynamic scanning profiles 128, both of which are discussed in greater detail below.

The private network 104 can also comprise additional components 138 known to those of ordinary skill in the art. For example, the private network 104 can also comprise one or more LANs that communicatively couples the access points 114 to a firewall. A firewall intercepts incoming and outgoing data traffic to the private network 104 and either allows or denies the traffic according to various security policies. The firewall wall can also be communicatively coupled to the Internet 118.

The circuit services network 102 (a GSM network in the example of FIG. 1) provides, among other things, voice services to the wireless device 106. The circuit services network 102 comprises a Wireless Wide Area network 130 that is communicatively coupled to one or more base stations 132. A site controller 134 is communicatively coupled to the base station 132. Additional components 136 that are known to those of ordinary skill in the art are also included in the circuit services network 102. For example a base station controller that controls and manages a set of base stations can be included. The base station controller can be communicatively coupled to a mobile switching center (“MSC”) that provides various services such as GSM services, circuit-switch calling, and the like to wireless devices roaming within the area that the MSC serves.

Additional network components 136 such as a Gateway GPRS Support Node/Serving GPRS Support Node (“GGSN/SGSN”) can also be included. The GGSN, in one embodiment, provides the connectivity to the SGSN an IP network such as the Internet 118 and detunnels user data from GPRS Tunneling Protocol. The SGSN establishes the Packet Data Protocol with the GGSN and implements packet scheduling policies.

The circuit services network 102 and the private network 104 can support any number of wireless devices 106. The support of the networks 102, 104 includes support for mobile telephones, smart phones, text messaging devices, handheld computers, wireless communication cards, pagers, beepers, or the like. A smart phone is a combination of 1) a pocket PC, handheld PC, palm top PC, or Personal Digital Assistant (“PDA”), and 2) a mobile telephone. More generally, a smartphone can be a mobile telephone that has additional application processing capabilities.

Dynamic Adjustment of Alternate Network Scanning Frequency

As discussed above, a multi-mode wireless device 106 is capable of communicating over multiple wireless technologies. Current multi-mode wireless devices frequently scan for networks such as WLAN networks. However, the wireless device 106 may not be in an area where WLAN coverage exists or compatible WLAN coverage is provided. Therefore, frequency scanning in these areas unnecessarily drains the device's battery. Accordingly, one of the advantages of the present is that the frequency of scans for other networks can be dynamically adjusted based on the location of the wireless device, time of day, and other factors.

In one embodiment of the present invention, the wireless device monitor 120 in the UNC 116 detects when the wireless device 106 registers with a WLAN 112. When the wireless device 106 registers with a WLAN 112, it transmits information such as the current GSM cell ID, base station ID, and other data that overlap with the WLAN network to the UNC 116. The UNC 116 then sends this information to the logical entity 124.

The dynamic scanning profile generator 126 uses this information to create a master dynamic scanning profile 128. The master dynamic scanning profile 128, in one embodiment, is used by the logical entity 124 to create an optimized dynamic scanning profile 110 for the wireless device 106. This optimized dynamic scanning profile 110 is used by the wireless device 106 to dynamically adjust its scanning frequency for WLAN networks. For example, if the wireless device 106 is in an area that it frequently connects to WLANs, its dynamic scanning profile 110 can indicate to increase scanning frequency, e.g. from every 10 minutes to every 30 seconds. However, if the wireless device 106 is in an area where it has not connected to any WLANs in the past, its dynamic scanning profile 110 can indicate to increase scanning frequency, e.g. from every 30 seconds to every 20 minutes.

The GSM cell ID, base station ID, and other information (discussed in greater detail below) transmitted by the wireless device 106 is used by the logical entity 124 to determine various patterns such as time and location patterns for WiFi associations by the wireless device 106. In one embodiment, the logical entity 124 uses the information transmitted by the wireless device 106 to determine the base stations that are frequented the most by the wireless device 106. In this embodiment, the master dynamic scanning profile 128 includes a priority list of base station IDs and associated scanning intervals. More frequently registered base stations can be assigned a higher weight than less frequently registered base stations.

In one embodiment, the base station IDs with a higher weight are given a higher priority in the dynamic scanning profile 128. A higher priority base station ID is assigned a shorter scanning interval and lower priority base station ID is assigned a longer scanning interval. The weights allow the logical entity 124 to generate the optimized scanning profile 110 for the wireless device 106. The optimized scanning profile 110 is a subset of master dynamic scanning profile 128. The logical entity 124 can periodically update the optimized scanning profile 110 and send update sets to the wireless device 106. The wireless device 106 can also request an updated profile from the logical entity 124.

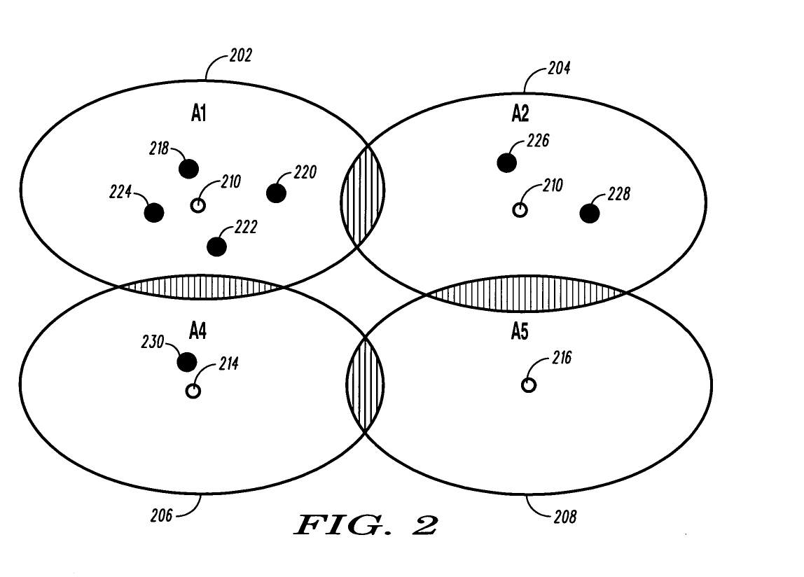

One example of dynamic scanning interval adjustment is shown in FIG. 2. FIG. 2 shows different coverage areas (cells) 202, 204, 206, 208 that are each serviced by different base stations 210, 212, 214, 216. Whenever the wireless device 106 connects to a WLAN the GSM cell ID and base station ID are transmitted by the wireless device 106 to the UNC 116 and passed on to the logical entity 124. If the wireless device 106 connects to WLANs more frequently in one cell than another, the base station ID of this cell is assigned a higher priority within the dynamic scanning profile 128. Consequently, a shorter scanning interval is also assigned to the base station ID within the dynamic scanning profile 128. For example, FIG. 2 shows that the wireless device 106 has registered with four WLANs 218, 220, 222, 224 in cell A1 202, two WLANs 226, 228 in cell A2 204, one WLAN 230 in cell A4 206, and no WLANs in cell A5 208.

As discussed above, the master dynamic scanning profile 128 generated by the logical entity 124 is used to create an optimized dynamic scanning profile 110 that is transmitted to the wireless device 106. Therefore, as the wireless device 106 registers with a base station it analyzes its dynamic scanning profile 110 to determine a WLAN scanning interval for that cell. For example, as the wireless device 106 registers with the base station 210 in cell A1 202, the wireless device 106 analyzes its dynamic scanning profile 110 to identify a WLAN scanning interval for this cell. In this example, the wireless device 106 has connected to the most WLANs in cell A1 202 than any other of the cells. Therefore, the dynamic scanning profile 110 indicates to the wireless device 106 to set a short scanning interval, e.g., every 10 seconds.

When the wireless device 106 registers with the base station 212 in cell A2 204, the wireless device 106 analyzes its dynamic scanning profile 110 to identify a WLAN scanning interval for cell A2 204. In this example, the wireless device 106 has connected to the second most WLANs in cell A2 204 than any other cell, so its dynamic scanning profile 110 indicates to the wireless device 106 to set a longer scanning interval than in cell A1 202 but shorter than the other cells, e.g., every 1 minute.

When the wireless device 106 registers with the base station 214 in cell A4 206, the wireless device 106 analyzes its dynamic scanning profile 110 to identify a WLAN scanning interval for cell A4 206. In this example, the wireless device 106 has connected to the third most WLANs in cell A4 206 than any other cell, so its dynamic scanning profile 110 indicates to the wireless device 106 to set a longer scanning interval than in cells A1 and A2 202, 204, but shorter than the cell A5 208, e.g., every 10 minutes. When the wireless device 106 registers with the base station 216 in cell A5 208, the wireless device 106 analyzes its dynamic scanning profile 110 to identify a WLAN scanning interval for cell A5 208. However, because the wireless device 106 has never connected to a WLAN in this cell its dynamic scanning profile 110 does not include scanning interval information for this cell. Therefore, the wireless device 106 uses a default scanning interval rate.

In another embodiment, network based cellular location technologies such as Enhanced Observed Time Difference (“EOTD”) technology, triangulation, GPS, and the other methods can be used by the logical entity 124 when creating the dynamic scanning profile 128 for the wireless device 106. In this embodiment, as the wireless device 106 registers with a WLAN 112, the UNC 116 or another logical entity 124 can determine the location of the wireless device 106. Therefore, the dynamic scanning profile 128 can include location information and associated scanning intervals.

For example, the wireless device 106 can analyze the dynamic scanning profile 128 to determine if a WLAN is nearby such as in the user's home, at a coffee shop, or other locations. If the dynamic scanning profile indicates that one or more WLANs are nearby, the wireless device 106 can adjust its scanning interval according to the interval indicated by the dynamic scanning profile. If the location is not listed in the profile or the profile indicates that a WLAN is not nearby, the wireless device 106 can maintain its current scanning rate or adjust to a longer interval to save battery life.

It should be noted that location information can be used in conjunction with base station ID information discussed above and time pattern information. For example, the logical entity 124 can determine that a user is generally away from a home WLAN between the hours of 9:00 a.m. to 5:00 p.m. (the user is away at work). One way that the logical entity 124 can determine this is by noting the time stamps associated with base station registrations or via a profile setup by the user. Therefore, the logical entity 124 can include in the dynamic scanning profile that that user is out of the coverage area for the base station associated with his/her home area between 9:00 a.m. to 5:00 p.m. If the wireless device 106 enters the cell comprising the user's home location between 9:00 a.m. to 5:00 p.m., a location profile can be used to modify the scanning interval accordingly.

In other words, as the wireless device travels back to his/her home and registers with different base stations, the logical entity 124 or wireless device 106 can determine if the user is approaching his/her home between 9:00 a.m. to 5:00 p.m. If the location of the wireless device yields that that it is within the same cell as the home or within a distance threshold, the wireless device can wake up its scanning module and adjust the scanning frequency to scan more often. It should also be noted that multiple profiles can also be created for the wireless device 106. For example, a time-base profile, location-based profile, a general profile, and other profiles can all be created separately. It should also be noted that the wireless device 106 can also transmit its position or at least information that can be used to calculate its position within the network.

As can be seen from the above discussion, one of the advantages of the present invention is that a wireless device 106 can dynamically adjust its network scanning intervals based on a dynamic scanning profile 110. Based on the dynamic scanning profile 110, the wireless device 106 can determine if it is near or far from a WLAN network 112. If the wireless device 106 determines that it is far away from a WLAN network 112 or at a distance greater than a given threshold, the wireless device 106 can dynamically adjust its network scanning interval to a longer interval (i.e., do not scan as frequently or at all). This prevents the battery of the device from unnecessarily being drained. If the wireless device 106 determines that near a WLAN network 112 or at a distance within or equal to a given threshold, the wireless device 106 can dynamically adjust its network scanning interval to a shorter interval (i.e., scan more frequently).

It should be noted that the present invention is not limited to the dynamic scanning profile being created by a network component such as a logical entity 124. For example, the wireless device 106 can also include a dynamic scanning profile generator 140. In this embodiment, two types of profiles can be created. The first type of dynamic scanning profile includes information regarding identified WLAN networks that the wireless device 106 has associated with or wants to associate with. The wireless device 106 actively learns the locations of alternative networks such as WLANS that are suitable for registration. In this embodiment, as well as the embodiments discussed above, location codes, which can comprise one or more of Location Area Codes (“LACs”), Cell IDs, and GPS coordinates (from the wireless device 106 and/or base station 132), and other data. LACs can be used along with Mobile Country Codes (“MCCs”), and Mobile Network Codes (“MNCs”) to uniquely identify a location area within the Public Land Mobile Network (“PLMN”).

In this embodiment, similar to the embodiment discussed above, when the wireless device 106 registers with a WLAN 112, it can record information such the base station ID, location of the cell, location of the device when it registered with the WLAN, time/date, and other information. This list is continuously updated by the wireless device. The location code can be expanded to different granularities such as a combination of location area and cell-id, which, in one example, can define the proximity of a workplace. In this example, the scanning frequency can be increased when the wireless device 106 is near the workplace.

As the list grows with WLAN locations and identifying information, the wireless device 106 can decrease or increase its scanning intervals as discussed above. For example, the wireless device 106 can analyze its dynamic scanning profile 110 that it created and determine that it is in an area with suitable WLAN coverage. Therefore, the wireless device 106 via its network scanning update module 108 increases the scanning frequency. If the wireless device determines that it is entering an area with minimal or no WLAN coverage it can decrease scanning frequency (e.g., performs scans at greater intervals) or turn off the WLAN radio completely.

The second type of dynamic scanning profile includes areas/locations that dot not provide WLAN coverage or suitable WLAN coverage. This dynamic scanning profile can also include WLANs that the user does not want to associate with or that the wireless device 106 has tried to associate with in the past and has failed. In other words non-accepted location areas (those on which it is unlikely to have WLAN coverage suited for registration) are learned by the wireless device 106 as it moves on the WAN system. In one embodiment, the first dynamic scanning profile and the second dynamic scanning profile are independent and do not overlap. In other words, if an LAC is already present on first dynamic scanning profile then it is not included in the second dynamic scanning profile. If a wireless device 106 detects a WLAN that is has never associated with, the wireless device 106 can place the new WLAN on any of the first or second dynamic scanning profiles. A new profile can also be generated that includes new WLANs. Once the wireless device 106 associates with one of these WLANs, the WLAN can be moved from the “new” profile to either the first or second scanning profiles (depending on the success of registration).

It should be noted that in the embodiment discussed above that if a WLAN listed in the dynamic scanning profile 110 is unavailable the wireless device 106 can further increase its scanning frequency for identifying another WLAN. Also, if the wireless device 106 stays in an area located on second dynamic scanning profile (the profile including locations not providing WLAN coverage), the wireless device 106 can further reduce the scanning frequency.

Also, the dynamic scanning profile 110 residing at the wireless device 106 can be erased, for example, by resetting the wireless device 106. However, the dynamic scanning profile 110 can also be configured to retain its information until a user manual selects an option to erase the contents of the dynamic scanning profile 110. In another embodiment, the wireless device can receive and transmit its scanning profiles or the identified locations of alternate networks from/to other wireless devices. In this embodiment, the wireless device 106 can then cross-reference its own profile and update it accordingly. These profiles can also be sent to a network component such as the logical entity 124 that maintains a master dynamic scanning profile 127. The logical entity 124 can then update device lists based on information received from all wireless devices it serves.

It should be noted that the dynamic scanning profiles, base-station IDs, LAC information, and other information can be sent to/from the wireless device 106 through the circuit services network such as the GSM network 102 or through the alternative network such as the private network 104. Also, the present invention is not limited to multi-mode devices. For example, a single-mode device that scans for networks to communicate over is also applicable to the present invention. In this embodiment, the single-mode device can use the dynamic profiles either that it creates or receives from a network component, as discussed above, to increase or decrease its scanning intervals.

Examples of Dynamic Scanning Profiles

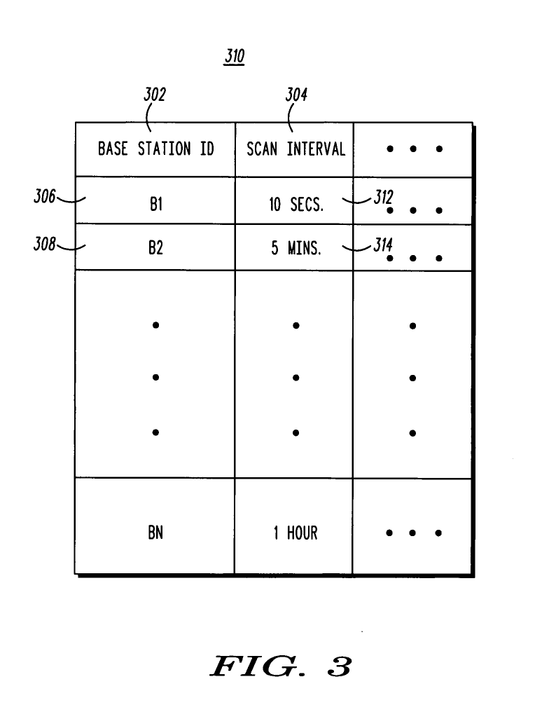

FIGS. 3-5 illustrate various examples of dynamic scanning profiles. It should be noted that the dynamic scanning profiles shown in FIGS. 3-5 are only illustrative. The profiles can be configured in other ways and include different information than what is shown in FIGS. 3-5. FIG. 3 shows a dynamic scanning profile 310 that can reside on the wireless device 106. In one embodiment, the dynamic scanning profile 310 is an optimized profile that a logical entity 124 has created from a master dynamic scanning profile associated wireless device 106. It should be noted that the wireless device 106 can also generate this dynamic scanning profile 310 as discussed above.

The dynamic scanning profile 310 of FIG. 3 includes one or more columns such as a Base Station ID column 302 and a Scanning Interval column 304. The Base Station ID column 302 includes one or more entries such as a first entry 306 and a second entry 308. The first entry 306 includes a base station ID associated with a first base station and the second entry 308 includes a base station ID associated with a second base station. The Scan Interval column 304 includes entries including scan interval information associated with base stations. For example, a first entry 310 includes a scanning interval of 10 seconds associated with the first base station and a second entry 312 includes a scanning interval of 5 minutes associated with the second base station.

In one embodiment, when the wireless device 106 registers with the first base station, it analyzes the dynamic scanning profile 310 and locates the base station ID associated with the first base station. The wireless device 106 also identifies the scan interval associated with first base station and adjusts its scanning interval to 10 seconds.

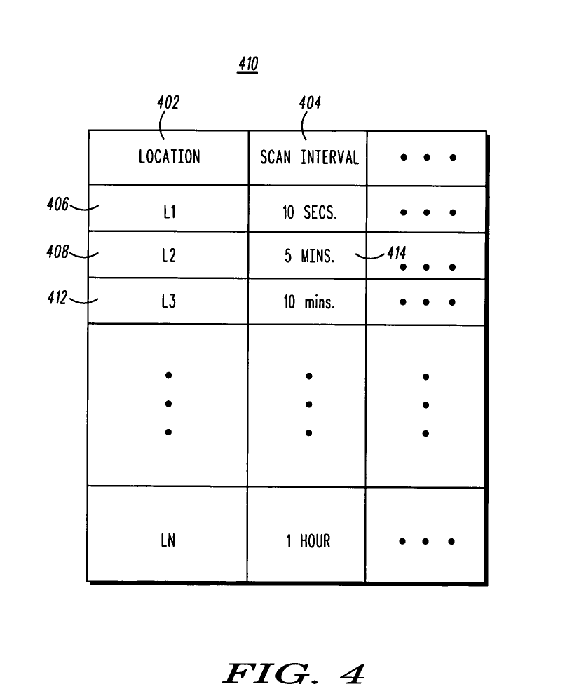

FIG. 4 shows another dynamic scanning profile 410 used by the wireless device 106 to adjusts its scanning interval. The dynamic scanning profile 410, in one embodiment, is generated by the wireless device 106 as it learns what areas provide suitable WLAN coverage for registration. The dynamic scanning profile 410, in the example of FIG. 4, includes a Location column 402, a Scan Interval column 404, and other data. The Location column includes various entries such as entry A 406, entry B 408, and entry C 412. Each entry includes location information such as GPS coordinates, cell locations information, and other data of an area that includes a WLAN network that the wireless device 106 can register with. It should be noted that the dynamic scanning profile 410 can use base station IDs or any other types of information discussed above instead of location information.

As the wireless device 106 enters into an area identified by the dynamic scanning profile 410, the wireless device 106 identifies an associated scanning interval for that location. For example, the Scan Interval column includes entries comprising scan interval information associated with each location entry. If the wireless device 106 enters into location L2, the wireless device 106 analyzes the dynamic scanning profile 410 and locates entry D 414 under the Scan Interval column 404. Entry D 414 indicates to the wireless device 106 to adjust its scanning interval to 5 minutes.

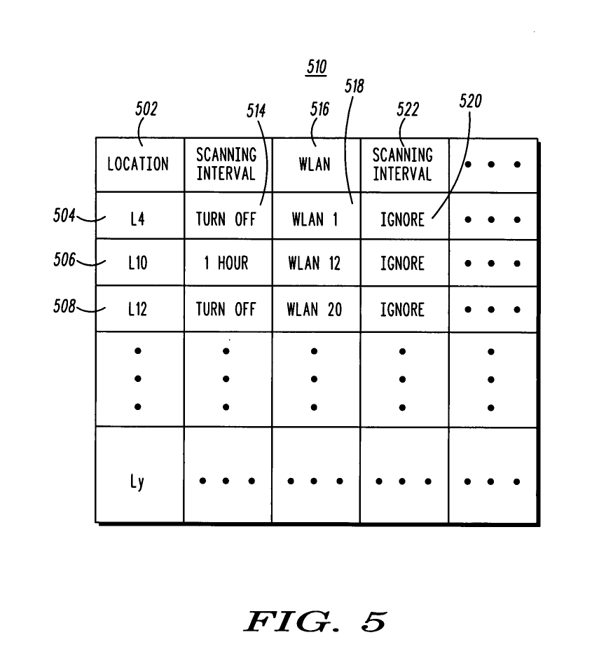

FIG. 5 shows another dynamic scanning profile 510 that can be generated by the wireless device 106. The dynamic scanning profile 510, in one embodiment, includes information regarding areas that do not provide suitable WLAN networks for the wireless device 106 to register on. The dynamic scanning profile 510 can also include user added entries identifying areas or WLAN networks that the user does not want to connect to. Therefore, in one embodiment, each column of the dynamic scanning profile 510 of FIG. 5 is independent of one another.

For example, the dynamic scanning profile 510 includes a Location column 502 with entries such as entry A 504, entry B 506, and entry C 508. Each of these entries under the Location column 502 identifies a location or area that does not provide suitable WLAN coverage for the wireless device 106. In one embodiment, a scanning interval can be associated with these areas. For example, under a first Scanning Interval column 512, an entry such as entry D 514 indicates that the scanning module of the wireless device 106 is to be turned off while the wireless device 106 is in location L4. In another embodiment, the dynamic scanning profile 510 can also includes a set of WLANs that are not suitable for the wireless device 106 or that the user has manually indicated to not connect with. For example, under a WLAN column 516, and entry such as entry E 518 identifies WLAN 1. A scanning interval entry 520 under a second Scanning Interval column 522 indicates that the wireless device 106 is to ignore this WLAN.

As can be seen from the above discussion, the present invention advantageously allows as a wireless device 106 to dynamically adjust its network scanning intervals based on a dynamic scanning profile 110, which can be created by the wireless device 106 or provided by a network component such as an logical entity 124. Based on the dynamic scanning profile 110, the wireless device 106 can determine if it is near or far from a WLAN network 112. If the wireless device 106 determines that it is far away from a WLAN network 112 or at a distance greater than a given threshold, the wireless device 106 can dynamically adjust its network scanning interval to a longer interval (i.e., do not scan as frequently or at all). This prevents the battery of the device from unnecessarily being drained. If the wireless device 106 determines that near a WLAN network 112 or at a distance within or equal to a given threshold, the wireless device 106 can dynamically adjust its network scanning interval to a shorter interval (i.e., scan more frequently).

Wireless Communication Device

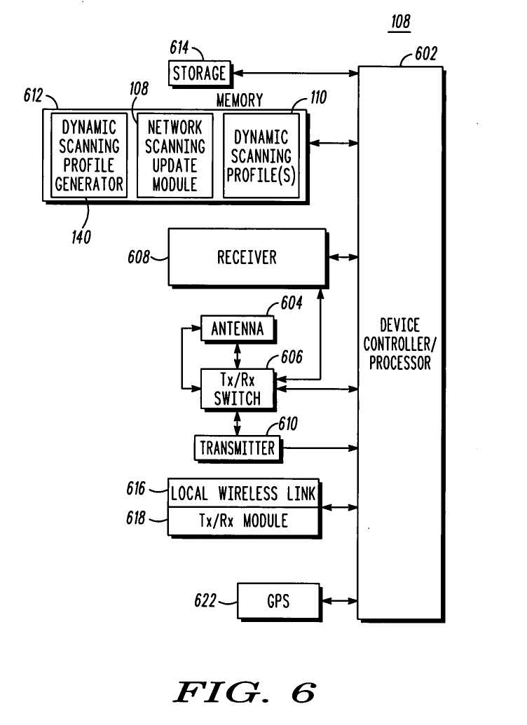

FIG. 6 is a block diagram illustrating a detailed view of the wireless device 106 according to an embodiment of the present invention. FIG. 6 illustrates only one example of a wireless communication device type. It is assumed that the reader is familiar with wireless communication devices. To simplify the present description, only that portion of a wireless communication device that is relevant to the present invention is discussed.

The wireless device 106 operates under the control of a device controller/processor 602, that controls the sending and receiving of wireless communication signals. In receive mode, the device controller 602 electrically couples an antenna 604 through a transmit/receive switch 606 to a receiver 608. The receiver 608 decodes the received signals and provides those decoded signals to the device controller 602.

In transmit mode, the device controller 602 electrically couples the antenna 604, through the transmit/receive switch 606, to a transmitter 610. It should be noted that in one embodiment, the receiver 608 and the transmitter 610 are a multi-mode receiver and a multi-mode mode transmitter for receiving/transmitting on wide area and local area networks. In another embodiment a separate receiver and transmitter is used for each of the wide area and local area networks, respectively.

The device controller 602 operates the transmitter and receiver according to instructions stored in the memory 612. These instructions include, for example, a neighbor cell measurement-scheduling algorithm. The memory 612, in one embodiment, also includes network scanning update module 108, dynamic scanning profile(s) 110, and dynamic scanning profile generator 140, which have discussed above in greater detail. The wireless device 106, also includes non-volatile storage memory 614 for storing, for example, an application waiting to be executed (not shown) on the wireless device 106. The wireless device 106, in this example, also includes an optional local wireless link 616 that allows the wireless device 106 to directly communicate with another wireless device without using a wireless network (not shown). The optional local wireless link 616, for example, is provided by Bluetooth, Infrared Data Access (IrDA) technologies, or other technologies.

The optional local wireless link 616 also includes a local wireless link transmit/receive module 618 that allows the wireless device 106 to directly communicate with another wireless device such as wireless communication devices communicatively coupled to personal computers, workstations. It should be noted that the optional local wireless link 616 and the local wireless link transmit/receive module 618 can be used to communicated within the private network 104 as discussed above. A GPS module 622 can also be included that allows the wireless device to determine its current location.

Information Processing System

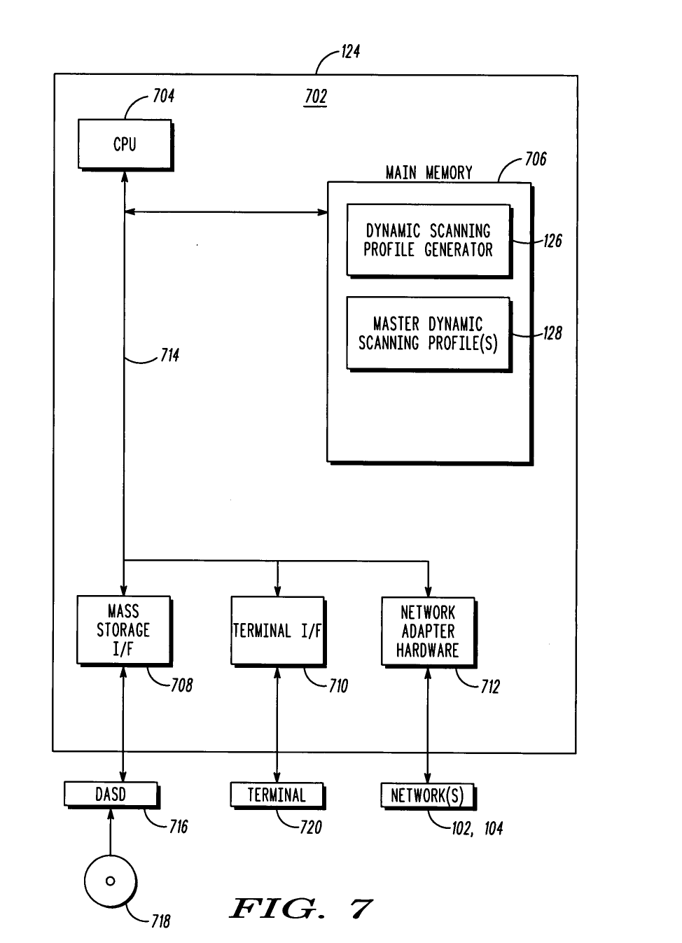

FIG. 7 is a block diagram illustrating a detailed view of the logical entity 124 according to an embodiment of the present invention. The logical entity 124 is based upon a suitably configured processing system adapted to implement the embodiment of the present invention. Any suitably configured processing system is similarly able to be used as the logical entity 124 by embodiments of the present invention. For example, a personal computer, workstation may be used.

The logical entity 124 includes a computer 702. The computer 702 has a processor 704 that is connected to a main memory 706, a mass storage interface 708, a terminal interface 710, and network adapter hardware 712. A system bus 714 interconnects these system components. The mass storage interface 708 is used to connect mass storage devices such as data storage device 716 to the logical entity 124. One specific type of data storage device is a computer readable medium such as a CD drive, which may be used to store data to and read data from a CD 718. Another type of data storage device is a data storage device configured to support New Technology File System (“NTFS”) operations, UNIX operations, or other operations.

The main memory 706 includes, among other things, the dynamic scanning profile generator 126 and the master dynamic scanning profile(s) 128, which have been discussed in greater detail above. It should be noted that respective components of the main memory 706 are not required to be completely resident in the main memory 706 at all times or even at the same time. Terminal interface 710 is used to directly connect one or more terminals 720 to computer 702 to provide a user interface to the logical entity 124. These terminals 720, which are able to be non-intelligent or fully programmable workstations, are used to allow system administrators and users to communicate with the logical entity 124. The terminal 720 is also able to consist of user interface and peripheral devices that are connected to computer 702 and controlled by terminal interface hardware included in the terminal I/F 710 that includes video adapters and interfaces for keyboards, pointing devices, and other devices.

An operating system (not shown) included in the main memory is a suitable multitasking operating system such as the Linux, UNIX, Windows XP, and Windows Server 2005 operating system. Embodiments of the present invention are able to use any other suitable operating system. The network adapter hardware 712 is used to provide an interface to the circuit services network 102 and the packet data network 104. Embodiments of the present invention are able to be adapted to work with any data communications connections including present day analog and/or digital techniques or via a future networking mechanism.

Although the embodiments of the present invention are described in the context of a fully functional computer system, those skilled in the art will appreciate that embodiments are capable of being distributed as a program product via CD, e.g. CD 718, floppy-disk, or other form of recordable media, or via any type of electronic transmission mechanism.

Process of a Logical Entity Creating a Dynamic Scanning Profile

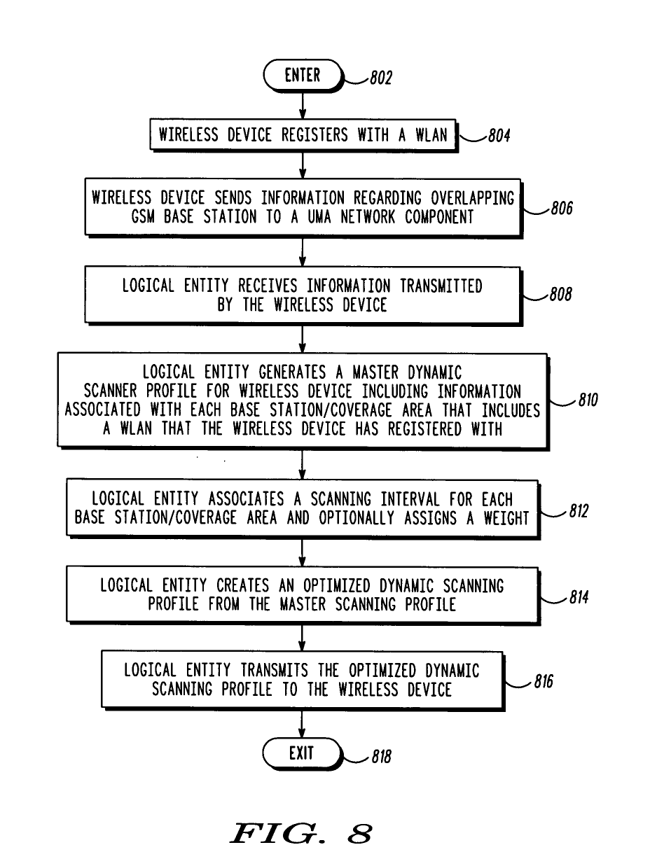

FIG. 8 is an operational diagram illustrating a process of a logical entity 124 such as an application server creating a dynamic scanning profile 128/110 for a wireless device 106. It should be noted that an application server is only one example of a logical entity where the present invention can be implemented. The present invention can also be implemented across multiple logical entities. The operational flow diagram of FIG. 8 begins at step 802 and flows directly to step 804. The wireless device 106, at step 804, registers with a WLAN 112. The wireless device 106, at step 806, sends information regarding overlapping the GSM base station to a private network component such as the UNC 116. The UNC 116, at step 808, forwards the information to a logical entity 124. The logical entity 124, at step 810, generates a master dynamic scanning profile 128 for the wireless device 106. The master dynamic scanning profile 128 includes information associated with each base station/coverage area that includes a WLAN that the wireless device 106 has registered with.

The logical entity 124, at step 812, associates a scanning interval for each base station/coverage area and optionally assigns a weight. The logical entity 124, at step 814, creates an optimized dynamic scanning profile 110 from the master dynamic scanning profile 128. The logical entity 124 transmits the optimized dynamic scanning profile 110 to the wireless device 106. The control flow then exits at step 818.

Process of a Wireless Device Dynamically Adjusting its Scanning Interval

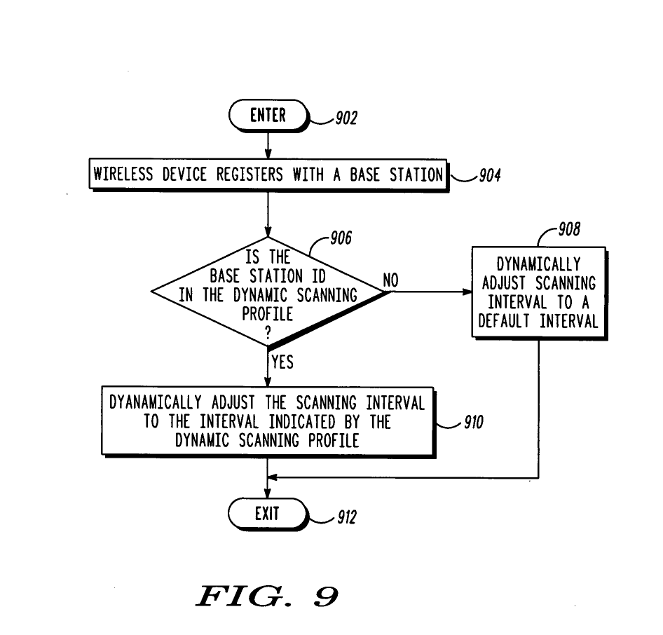

FIG. 9 is an operational diagram illustrating a process of a wireless device 106 dynamically adjusting its scanning interval based on a dynamic scanning profile 110. The operational flow diagram of FIG. 9 begins at step 902 and flows directly to step 904. The wireless device 106, at step 904, registers with a base station 132. The wireless device 106, at step 906, determines if the base station ID associated with the base station 132 is in its dynamic scanning profile 110. If the result of this determination is negative, the wireless device 106, at step 908, adjusts its scanning interval to a default interval. The control flow exits at step 912. If the result of this determination is positive, the wireless device 106, at step 910, dynamically adjusts the scanning interval to the interval indicated by its dynamic scanning profile 110. The control flow then exits at step 912.

Process of a Wireless Device Creating a Dynamic Scanning Profile

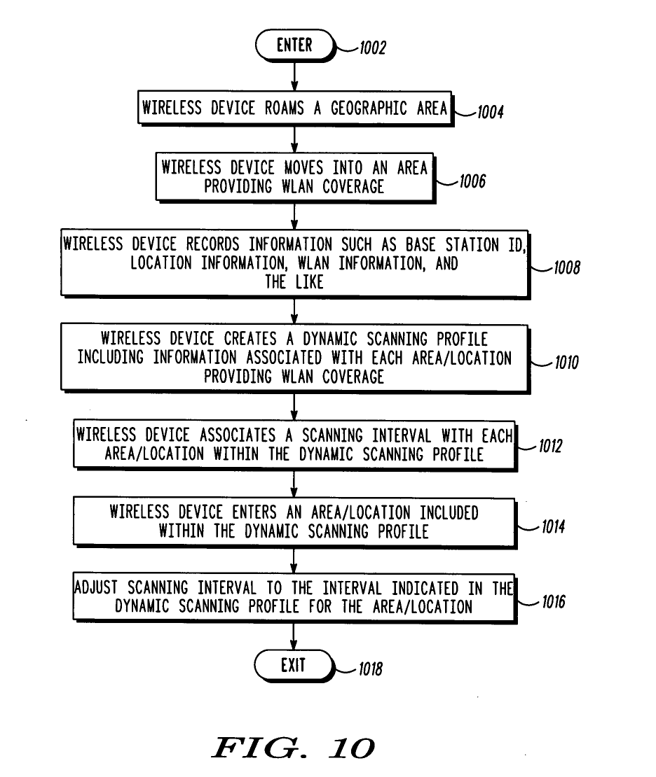

FIG. 10 is an operational diagram illustrating a process of a wireless device 106 creating a dynamic scanning profile 110. The operational flow diagram of FIG. 10 begins at step 1002 and flows directly to step 1004. The wireless device 106, at step 1004, roams a geographic area. The wireless device 106, at step 1006, moves into an area providing WLAN coverage. The wireless device 106, at step 1008, records information such as base station ID, location information, WLAN information, and other information.

The wireless device 106, at step 1010, creates a dynamic scanning profile 110 that includes information associated with each area/location providing WLAN coverage. The wireless device 106, at step 1012, associates a scanning interval with each area/location within the dynamic scanning profile 110. The wireless device 106, at step 1014, enters an area/location included within the dynamic scanning profile 110. The wireless device 106, at step 1016, dynamically adjusts its scanning interval to the interval indicated in the dynamic scanning profile 110 for the area/location. The control flow then exits at step 1018.

Another Process of a Wireless Device Creating a Dynamic Scanning Profile

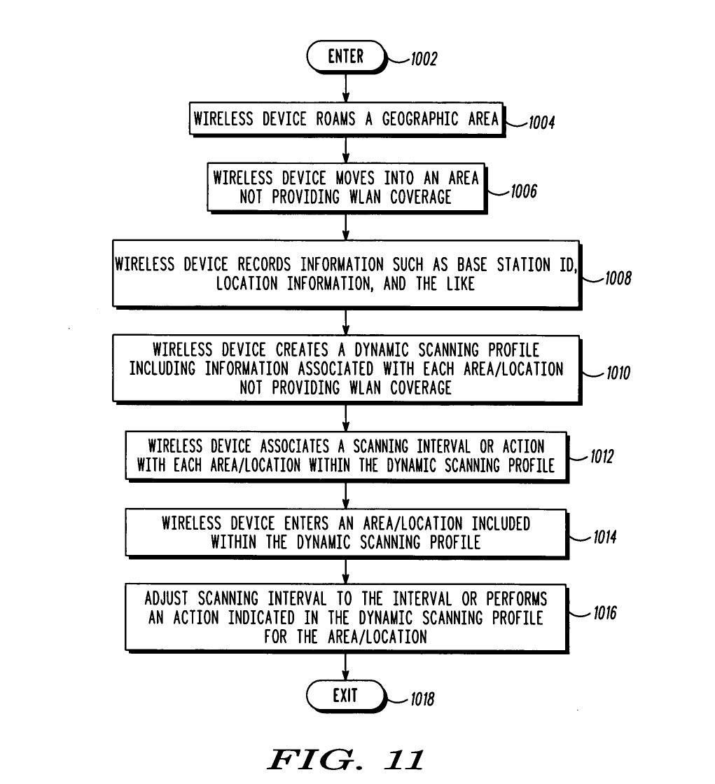

FIG. 11 is an operational diagram illustrating another process of a wireless device 106 creating a dynamic scanning profile 110. The operational flow diagram of FIG. 11 begins at step 1102 and flows directly to step 1104. The wireless device 106, at step 1104, roams a geographic area. The wireless device 106, at step 1106, moves into an area not providing WLAN coverage. The wireless device 106, at step 1108, records information such as base station ID, location information, and other information.

The wireless device 106, at step 1110, creates a dynamic scanning profile 110 that includes information associated with each area/location not providing WLAN coverage. The wireless device 106, at step 1112, associates a scanning interval or action such as “ignore” with each area/location within the dynamic scanning profile 110. The wireless device 106, at step 1114, enters an area/location included within the dynamic scanning profile 110. The wireless device 106, at step 1116, dynamically adjusts its scanning interval to the interval or performs an action such as “ignore” indicated in the dynamic scanning profile 110 for the area/location. The control flow then exits at step 1118.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with a wireless device, for managing network scanning intervals, the method comprising:
detecting a new wireless network coverage area;
analyzing, in response to the determining, at least one local dynamic scanning profile;
determining, in response to the analyzing, that the at least one local dynamic scanning profile includes identification information associated with the new wireless network coverage area; and
dynamically adjusting, in response to determining that the at least one local dynamic scanning profile includes the identification information, a network scanning interval for identifying wireless sub-networks within the new wireless network coverage area based on a scanning interval indicated by the at least one local dynamic scanning profile for the wireless network coverage area.

2. The method of claim 1, further comprising:
registering with a second network while being registered on a first network; and
transmitting information associated with the first network to a network component communicatively coupled to the second network.

3. The method of claim 2, wherein the network component generates a master dynamic scanning profile associated with the wireless device in response to the information associated with the first network.

4. The method of claim 3, wherein the at least one local dynamic scanning profile is generated by the network component from the master dynamic scanning profile and is received from the network component.

5. The method of claim 2, wherein the information associated with the first network is at least one of:
a base station ID; and
Global Positioning Satellite coordinates.

6. The method of claim 1, wherein the dynamically adjusting further comprises:
dynamically decreasing the network scanning interval so that network scanning occurs more frequently than a current network scanning interval.

7. The method of claim 1, wherein the dynamically adjusting further comprises:
dynamically increasing the network scanning interval so that network scanning occurs less frequently than a current network scanning interval.

8. The method of claim 1, further comprising:
generating the at least one local dynamic scanning profile, wherein the at least one local dynamic scanning profile includes at least wireless network coverage area identification information and a set of scanning intervals associated with a set wireless sub-network coverage areas corresponding to the wireless network coverage identification information.

9. The method of claim 8, wherein the at least one local dynamic scanning profile includes information associated with at least one geographic area providing Wireless Local Area Network (“WLAN”) coverage.

10. The method of claim 8, wherein the at least one local dynamic scanning profile includes information associated with at least one geographic area failing to provide WLAN coverage.

11. The method of claim 2, wherein the first network is a circuit services network and the second network is a Wireless Local Area Network.

12. An information processing system for managing network scanning intervals associated with at least one wireless device, the information processing system comprising:
a memory;
a processor communicatively coupled to the memory; and
a network scanning interval manager communicatively coupled to the memory and the processor, wherein the network scanning interval manager is adapted to:
receiving identifying information associated with a wireless network coverage area from a wireless device, when the wireless device registers with a WLAN network while being registered with the wireless network coverage area;
generating a master dynamic scanning profile associated with the wireless device in response to receiving the identifying information associated wireless network coverage area, wherein the master dynamic scanning profile includes at least identifying information associated with each wireless network coverage area that overlaps with a WLAN network registered on by the wireless device and a scanning interval associated with each wireless network coverage area; and
transmitting an optimized dynamic scanning profile to the wireless device including at least a subset of the identifying information associated with each wireless network coverage area network and the scanning interval associated with each wireless network coverage area network corresponding to the subset of the identifying information.

13. The information processing system of claim 12, wherein scanning interval instructs the wireless device to at least one of dynamically increase a network scanning interval and dynamically decrease a scanning interval;

14. The information processing system of claim 12, wherein the identifying information is at least one of:
a base station ID; and
global positioning satellite coordinates.

15. A wireless device, the wireless device comprising:
a memory;
a processor communicatively coupled to the memory; and
a network scanning manager communicatively coupled to the memory and the processor, wherein the network scanning manager is adapted to:
detect a new wireless network coverage area;
analyze, in response to the determining, at least one local dynamic scanning profile;
determine, in response to the analyzing, that the at least one local dynamic scanning profile includes identification information associated with the new wireless network coverage area; and
dynamically adjust, in response to determining that the at least one local dynamic scanning profile includes the identification information, a network scanning interval for identifying wireless sub-networks within the new wireless network coverage area based on a scanning interval indicated by the at least one local dynamic scanning profile for the wireless network coverage area.

16. The wireless device of claim 15, wherein the network scanning manager is further adapted to:
registering with a second network while being registered on a first network; and
transmitting information associated with the first network to a network component communicatively coupled to the second network.

17. The wireless device of claim 16, wherein the at least one local dynamic scanning profile is generated by the network component.

18. The wireless device of claim 15, wherein the dynamically adjusting further comprises at least one of:
dynamically decreasing the network scanning interval so that network scanning occurs more frequently than a current network scanning interval; and
dynamically increasing the network scanning interval so that network scanning occurs less frequently than a current network scanning interval.

19. The wireless device of claim 15, wherein the network scanning manager is further adapted to:
generating the at least one local dynamic scanning profile, wherein the at least one local dynamic scanning profile includes at least wireless network coverage area identification information and a set of scanning intervals associated with a set of coverage areas corresponding to the wireless network coverage area coverage area identification information.

20. The wireless device of claim 19, wherein the at least one local dynamic scanning profile includes information associated with at least one of a set geographic areas providing Wireless Local Area Network coverage and information associated with a set of geographic areas failing to provide Wireless Local Area Network coverage.
